(19) United States
(12) Patent Application Publication
(10) Pub. No.: US 2008/0144695 A1
(43) Pub. Date: Jun. 19, 2008

(54) SUBSTRATE FOR TEMPERATURE MEASUREMENT AND TEMPERATURE MEASURING SYSTEM

(75) Inventor: Tetsuya Hamada, Kyoto (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sokudo Co., Ltd., Shimogyo-ku (JP)

(21) Appl. No.: 11/947,629

(22) Filed: Nov. 29, 2007

(30) Foreign Application Priority Data
Nov. 30, 2006 (JP) JP2006-323359

(51) Int. Cl. G01K 11/00

(52) U.S. Cl. 374/117; 374/E11.001

(57) ABSTRACT

A substrate for temperature measurement has seventeen temperature measuring elements mounted thereto and each having a built-in quartz resonator. Each of the temperature measuring elements is connected to one coaxial cable covered with fluorocarbon resin having excellent heat resistance. The seventeen cables are bonded to the substrate for temperature measurement using an adhesive so that all the paths of the cables from their contacts with the temperature measuring elements to their boundary points to the outside of the substrate run on the upper surface of the substrate for temperature measurement, and that they are made to have a substantially equal length from their contacts to their boundary points. This minimizes and makes uniform thermal disturbances given to each of the temperature measuring elements from the cables, thus enabling high-precision substrate temperature measurement.

### CROSS-REFERENCES TO RELATED APPLICATIONS

This application claims priority to Japanese Patent Application 2006-323359, filed Nov. 30, 2006, the disclosure of which is hereby incorporated by reference in its entirety for all purposes.

### BACKGROUND OF THE INVENTION

The present invention relates to a substrate for temperature measurement which is placed on a heat-treat plate for heat treatment of a substrate such as a semiconductor substrate, a liquid crystal display glass substrate, a photomask glass substrate, and an optical disk substrate, and also relates to a temperature measuring system for measuring the temperature of a substrate placed on a heat-treat plate, using the substrate for temperature measurement.

As is generally known, products such as semiconductors and liquid crystal displays are manufactured through a series of processes on the aforementioned substrate, such as cleaning, resist coating, exposure, development, etching, interlayer insulation film formation, heat treatment, and dicing. Out of these processes, heat treatment, which is performed, for example, after pattern exposure, after coating of a spin-on-glass (SOG) material, which is a material of interlayer insulation film, or after photoresist coating, is a common process in the manufacture of semiconductors or liquid crystal displays. Thus, a heat treatment unit for heat treatment of substrates is used to measure the temperature of a substrate as precisely as possible. For example, Japanese Patent Application Laid-open No. 2002-124457 discloses a device provided with a temperature sensor formed on a substrate and providing a cable connection between the temperature sensor and a transmitter for transmission of detected data. Also, Japanese Patent Application Laid-open No. 11-307606 discloses a technique in which a temperature sensor and a transmitter or memory is provided on a substrate for temperature measurement.

In addition, Japanese Patent Application Laid-open No. 2004-140167 proposes a technique for temperature measurement using damped oscillation caused by resonance of quartz resonators, which are mounted on a substrate for temperature measurement, at a characteristic frequency. Quartz resonators have high heat resistance and besides are highly heat sensitive, thus enabling high-precision temperature measurement of even substrates with high temperature.

However, with recent progress toward developing more accurate design rules, the requirement for temperature accuracy for heat treatment of substrates is becoming more stringent than ever. Especially, the aforementioned heat treatment after photoresist coating has a direct impact on the film thickness and quality of resist film to be formed, and the heat treatment after exposure using a chemically amplifying resist has a direct impact on the pattern linewidths, so that heating a substrate precisely to a temperature required for each process is strongly desired. Thus, there is a need in the art for methods and systems to increase the accuracy of temperature measurement of substrates during heat treatment.

### SUMMARY OF THE INVENTION

The present invention is directed to a substrate for temperature measurement which is placed on a heat-treat plate for heat treatment of a substrate to be processed.

According to the present invention, the substrate for temperature measurement includes a substrate main body; a plurality of temperature measuring elements mounted to the substrate main body and each having a quartz resonator; and a plurality of cables individually connected to the plurality of temperature measuring elements to transmit electrical signals. All of the plurality of cables have a substantially equal length from their contacts with the temperature measuring elements to their boundary points to the outside of the substrate main body through on the substrate main body.

Since the plurality of cables have uniform thermal influences on the temperature measuring elements, the substrate temperature can be measured with extremely high precision.

Preferably, the plurality of cables from the contacts to the boundary points each are bonded to the substrate main body. Thus, the temperatures of the cables are made almost equal to that of the substrate for temperature measurement. This minimizes thermal disturbances given to the temperature measuring elements from the cables, thereby increasing the accuracy of substrate temperature measurement.

In an embodiment, the plurality of temperature measuring elements are mounted in recesses formed in a surface of the substrate main body.

Since the substrate for temperature measurement is made to have almost the same heat capacity as a common substrate to be processed, the temperature of the substrate can be measured with higher precision.

The present invention is also directed to a temperature measuring system in which the aforementioned substrate for temperature measurement is placed on a heat-treat plate for temperature measurement.

Therefore, an object of the present invention is to provide a temperature measuring system for measuring the temperature of a substrate with extremely high precision and to provide a substrate for temperature measurement for use in the system.

According to an embodiment of the present invention, a substrate for temperature measurement is provided. The substrate is configured to be placed on a heat-treat plate for heat treatment of a substrate to be processed. The substrate for temperature measurement includes a substrate main body having a top surface, a bottom surface, and a peripheral surface disposed therebetween. A boundary point is positioned on the peripheral surface. The substrate for temperature measurement also includes a plurality of temperature measuring elements mounted to the substrate main body. Each of the plurality of temperature measuring elements has a quartz resonator and a contact. The substrate for temperature measurement further includes a plurality of cables. Each of the plurality of cables is individually connected to one of the plurality of temperature measuring elements and configured to transmit electrical signals. Each of the plurality of cables also has a substantially equal length measured from the contact with the one of the plurality of temperature measuring elements to the boundary point positioned on the peripheral surface of the substrate main body.

According to another embodiment of the present invention, a temperature measuring system for measuring a temperature of a substrate placed on a heat-treat plate is provided. The temperature measuring system includes a substrate for temperature measurement. The substrate for temperature measurement includes a substrate main body having a top surface, a bottom surface, and a peripheral surface disposed therebetween. A boundary point is positioned on the peripheral surface. The substrate for temperature measurement also includes a plurality of temperature measuring elements mounted to the substrate main body. Each of the plurality of temperature measuring elements has a quartz resonator and a contact. The substrate for temperature measurement further includes a plurality of cables. Each of the plurality of cable is individually connected to one of the plurality of temperature measuring elements and configured to transmit electrical signals. Each of the plurality of cables has a substantially equal length measured from the contact with the one of the plurality of temperature measuring elements to the boundary point positioned on the peripheral surface of the substrate main body.

The temperature measuring system also includes a transmitter-receiver coupled to the plurality of cables. The transmitter-receiver is configured to transmit and receive electrical signals to and from each of the plurality of temperature measuring elements. The temperature measuring system further includes a temperature computer configured to compute the temperature of the substrate based on frequencies of electrical signals transmitted from each of the plurality of temperature measuring elements and received by the transmitter-receiver.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a substrate for temperature measurement with no temperature measuring element mounted thereto;

FIG. 2 is a partial enlarged view of the substrate for temperature measurement with a temperature measuring element mounted in its recess;

FIG. 3 is a plan view of the substrate for temperature measurement with temperature measuring elements mounted thereto;

FIG. 4 is an overall configuration view of a temperature measuring system in a first example;

FIG. 5 is a configuration view of the various parts of the temperature measuring system of FIG. 4;

FIG. 6 is an overall configuration view of a temperature measuring system in a second example; and

FIG. 7 is a configuration view of the essential parts of the temperature measuring system of FIG. 6.

### DETAILED DESCRIPTION OF THE INVENTION

Hereafter, embodiments of the present invention will be described in detail with reference to the drawings.

Substrate for Temperature Measurement

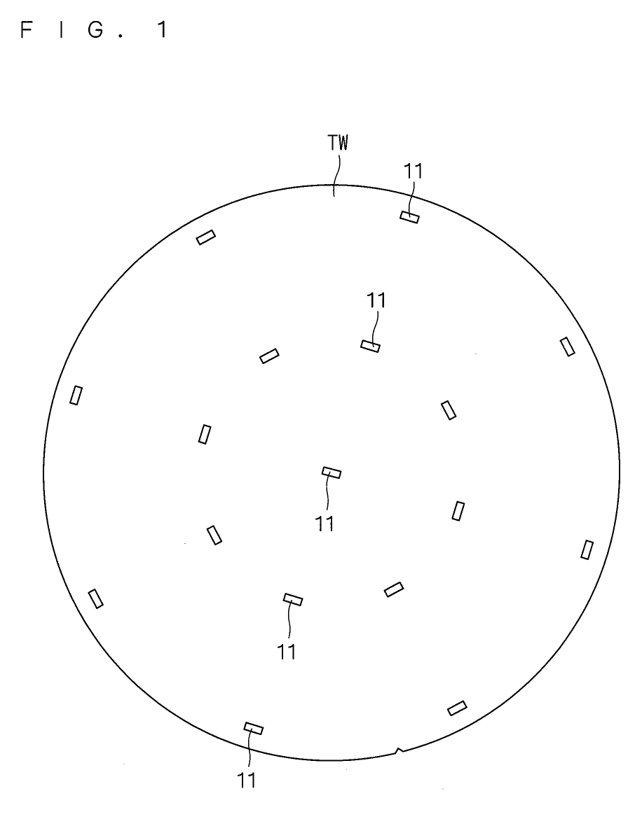

First, a substrate for temperature measurement according to the present invention will be described. FIG. 1 is a plan view of a substrate for temperature measurement TW with no temperature measuring element mounted thereto. The substrate for temperature measurement TW is formed of the same material and to the same size as a common semiconductor substrate to be processed, and according to this embodiment, it is a disc-shaped substrate of silicon of 300 mm in diameter. The substrate for temperature measurement TW has a plurality (17 in this illustrated embodiment) of recesses 11 formed in the surface. As shown in FIG. 1, the substrate for temperature measurement TW has one recess 11 formed in the center, eight recesses 11 formed at equal intervals of 45 degrees on the circumference of a circle with a radius of 140 mm in the surface, and eight recesses 11 formed at equal intervals of 45 degrees on the circumference of a circle with a radius of 280 mm in the surface. The plurality of recesses 11 each have a generally rectangular parallelepiped shape.

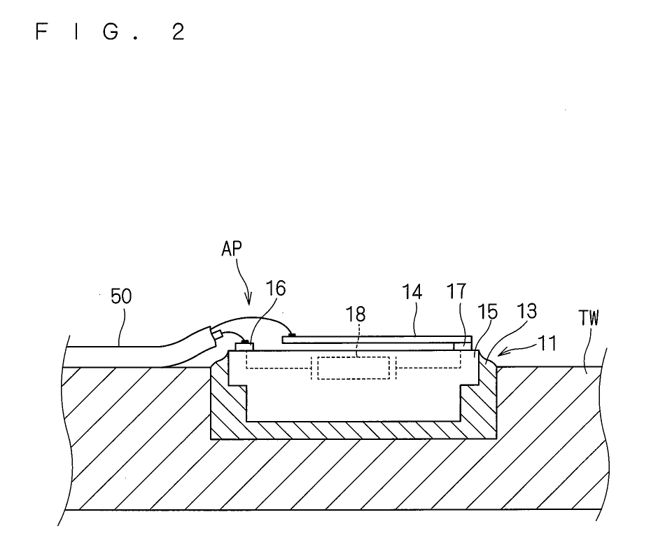

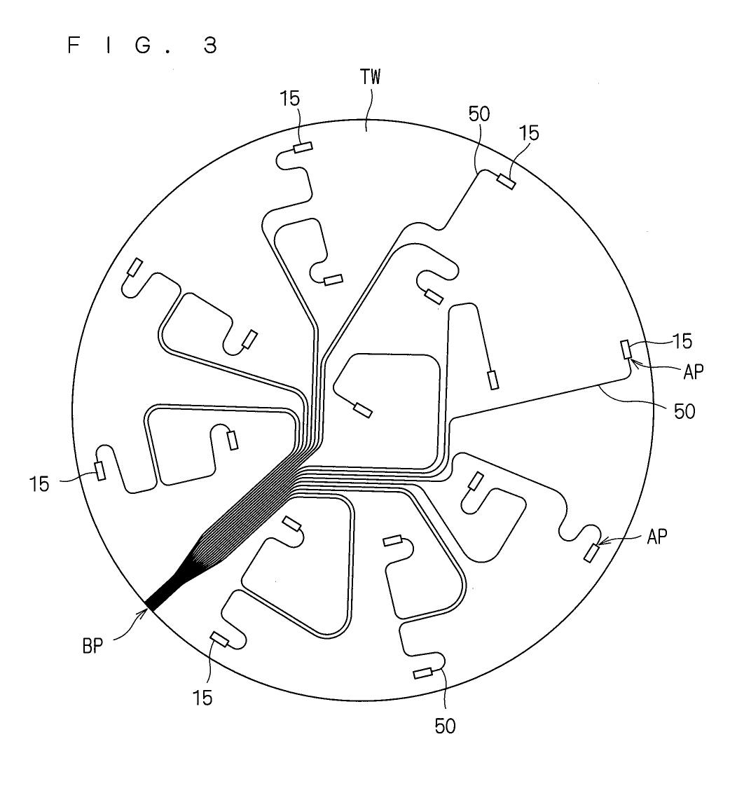

Mounting a temperature measuring element 15 in each of the seventeen recesses 11 and providing cables 50 each connected to one of the temperature measuring elements 15 on the substrate constitute the substrate for temperature measurement TW. FIG. 2 is a partial enlarged view showing that one of the temperature measuring elements 15 is mounted in one of the recesses 11. FIG. 3 is a plan view of the substrate for temperature measurement TW with the temperature measuring elements 15 mounted thereto. The temperature measuring elements 15 each are configured with a built-in quartz resonator 18 formed in a package. Quartz crystal has different characteristic frequencies and a wide variety of temperature characteristics depending on the cut angle of the crystal, out of which so-called Ys-cut quartz crystal has a high rate of change of transmit/receive frequencies with respect to temperature. Sending to the quartz resonators 18 electrical signals with frequencies corresponding to their characteristic frequencies and measuring the frequencies of electrical signals received from the quartz resonators 18 after the termination of the signal transmission enable computation of the temperatures of the temperature measuring elements 15 based on the rate of change of the transmit/receive frequencies. The use of quartz resonators, as compared with the use of resistance thermometer sensors or the like, results in temperature measurement with very high precision.

The plurality of recesses 11 each have a single temperature measuring element 15 mounted therein. That is, seventeen temperature measuring elements 15 are mounted to a single substrate for temperature measurement TW. More specifically, the temperature measuring elements 15 are bonded and fixed into the recesses 11 using an adhesive 13. The adhesive 13 employed, for example, has heat resistance and hardly generates gas even if its temperature is increased by heating (examples thereof include an electrically conductive silicone adhesive including a heat curing silicone resin kneaded with silver powder; and a polyimide varnish based on an aromatic polyimide with high thermal stability).

According to this illustrated embodiment, the temperature measuring elements 15 are not simply secured to the substrate surface, but inserted into the recesses 11 formed in the substrate surface. In a particular embodiment, the thickness of the substrate for temperature measurement TW is 0.72 mm, while the depth of the recesses 11 is 0.35 mm. That is, the recesses 11 are formed to a depth of about half the thickness of the substrate for temperature measurement TW. Thus, the temperature measuring elements 15 can measure the temperature of the center of the substrate for temperature measurement TW in the direction of the thickness of the substrate TW, which increases the accuracy of substrate temperature measurement.

As a result of forming the recesses 11 in order to bond and fix the temperature measuring elements 15 therein, the substrate for temperature measurement TW has almost the same weight as a common semiconductor substrate to be processed. From this, the substrate for temperature measurement TW and a common semiconductor substrate to be processed will have almost the same heat capacity and consequently will exhibit almost the same behaviors of temperature increase and decrease. This further increases the accuracy of substrate temperature measurement.

The temperature measuring elements 15 each have two electrodes 16 and 17 for transmission and reception, respectively, provided on the upper surface. The electrode 17 is further attached with a lead 14. The cables 50 are so-called coaxial cables with a diameter of 0.3 mm, and have their core wires joined to the electrodes 16 by soldering or the like and their shielded lines joined to the leads 14 (that is, the shielded lines are connected to the electrodes 17). The sheaths (the outermost protective coating) of the cables 50 are formed of fluorocarbon resin (e.g., Teflon (which is a registered trademark)) having excellent heat resistance.

As shown in FIG. 3, the cables 50 transmitting electrical signals to the temperature measuring elements 15 are arranged in a meandering shape on the substrate for temperature measurement TW. Since each of the seventeen temperature measuring elements 15 is connected to one of the cables 50, the substrate for temperature measurement TW has provided thereon seventeen cables 50. All the seventeen cables 50 are of a substantially equal length from their contacts AP (FIG. 2) with the temperature measuring elements 15 to their boundary points BP (FIG. 3) to the outside of the substrate for temperature measurement TW through on the surface of the substrate for temperature measurement TW.

The seventeen cable 50 respectively are fixed by bonding on the upper surface of the substrate for temperature measurement TW. Specifically, the cables 50 on the substrate for temperature measurement TW have substantially no freedom of movement and deformation, and they are bonded and fixed using an adhesive along the paths as shown in FIG. 3 on the upper surface of the substrate for temperature measurement TW. The adhesive used to fix the cables 50 may be the same as the aforementioned adhesive 13 used to bond and fix the temperature measuring elements 15 into the recesses 11.

In some embodiments of eth present invention, the paths of all the cables 50 from their contacts AP with the temperature measuring elements 15 to their boundary points BP to the outside of the substrate always run on the surface without deviating from and running outside of the substrate at all. In other words, the seventeen cables 50 are bonded to the substrate for temperature measurement TW so that all the paths of the cables 50 from the contacts AP with the temperature measuring elements 15 to the boundary points BP to the outside of the substrate run on the upper surface of the substrate for temperature measurement TW, and that they are made to have a substantially equal length from the contacts AP to the boundary points BP. While, in the example of FIG. 3, the seventeen cables 50 are tied together in a bundle in the vicinity of the boundary points BP, they are only tied together, but isolated from one another by their sheaths. In other words, the seventeen cables 50 are electrically independent of one another.

First Example of Temperature Measuring System

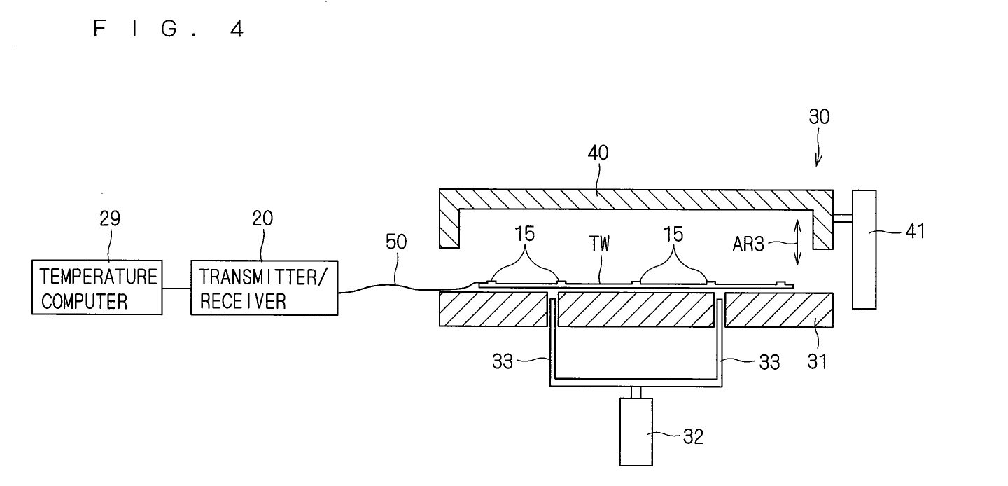

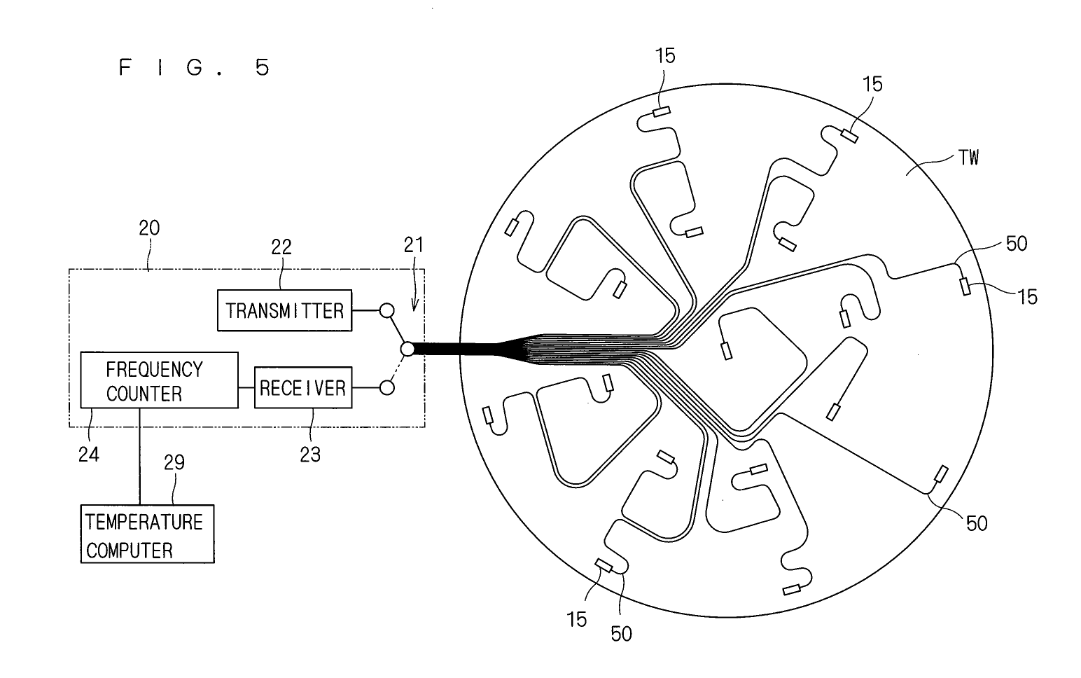

Next, a temperature measuring system using the aforementioned substrate for temperature measurement TW will be described. FIG. 4 is an overall configuration view of a temperature measuring system according to the present invention and FIG. 5 is a configuration view of the various parts of the system. In the present example, the temperature of a substrate placed on a heat-treat plate 31 in a heat processing unit 30 is measured using the substrate for temperature measurement TW.

The heat processing unit 30 includes the heat-treat plate 31 and a plate cover 40, which are held in a chamber (not shown). The heat-treat plate 31 is a circular plate of aluminum and has a built-in heater composed of a resistance heating element. The heat-treat plate 31 has, for example, three small ceramic balls (not shown) formed on its upper surface. A substrate to be processed is placed and heated on the heat-treat plate 31 with a predetermined gap (e.g., 0.1 mm) therebetween via the ceramic balls.

Below the heat-treat plate 31, an air cylinder 32 is provided to move a plurality (e.g., three) of support pins 33 upwardly and downwardly in unison. Tips of the support pins 33 are inserted in through holes vertically formed through the heat-treat plate 31. When the air cylinder 32 moves the support pins 33 upward, the tips of the support pins 33 project from the upper surface of the heat-treat plate 31, while, when the air cylinder 32 moves the support pins 33 downward, the tips of the support pins 33 return to a level below the upper surface of the heat-treat plate 31. The upward movement of the supports pins 33 allows a substrate to be lifted to a higher level, and the downward movement of the support pins 33 allows a substrate to be transported onto the heat-treat plate 31.

The plate cover 40 is provided to cover over the heat-treat plate 31. As indicated by the arrow AR3 in FIG. 4, the plate cover 40 is vertically movable by a lifting mechanism 41 between its standby position, which is spaced above from the heat-treat plate 31, and its processing position, which is in close proximity to the heat-treat plate 31. For heat treatment in the heat processing unit 30, the plate cover 40 is moved down to the processing position. For transport of a substrate into and out of the heat processing unit 30 by a transport robot (not shown), the plate cover 40 is moved up to the standby position. Here, various linear drive mechanisms, such as a screw feed mechanism using a ball screw, a belt feed mechanism using a belt, and an air cylinder can be employed as the lifting mechanism 41.

For substrate temperature measurement in the heat processing unit 30, the aforementioned substrate for temperature measurement TW is placed on the heat-treat plate 31. More specifically, the substrate for temperature measurement TW is placed by a transport robot or manually on the support pins 33 in its raised position, and then the support pins 33 are moved down to place the substrate for temperature measurement TW on the heat-treat plate 31.

The temperature measuring system of the first example provide individual connections (cable connections) between the respective seventeen temperature measuring elements 15 in the substrate for temperature measurement TW and a transmitter-receiver 20 via the cables 50. Specifically, the aforementioned seventeen cables 50 run from the contacts AP with the temperature measuring elements 15 to the transmitter-receiver 20, passing on the boundary points BP. As described above, the seventeen cables 50 are electrically isolated from and thus independent of one another.

The transmitter-receiver 20 includes a selector 21, a transmitter 22, a receiver 23, and a frequency counter 24 (FIG. 5). The selector 21 selects the destination of connection of each of the temperature measuring elements 15 between the transmitter 22 and the receiver 23. The transmitter 22 transmits electrical signals with predetermined frequencies to the quartz resonators 18 of the seventeen temperature measurement elements 15. The receiver 23 receives electrical signals from the quartz resonators 18 of the seventeen temperature measurement elements 15. The receiver 23 is connected to the frequency counter 24, which counts the frequencies of the electrical signals received by the receiver 23.

The frequency counter 24 is further connected to a temperature computer 29. The temperature computer 29 computes the temperature of the substrate for temperature measurement TW based on the frequencies of the electrical signals counted by the frequency counter 24. The transmitter-receiver 20 and the temperature computer 29 may be incorporated into part of the heat processing unit 30, or they may be provided separately outside the heat processing unit 30. When incorporated into part of the heat processing unit 30, the transmitter-receiver 20 and the temperature computer 29 may be controlled by a controller of the heat processing unit 30. When provided outside the heat processing unit 30, the transmitter-receiver 20 and the temperature computer 29 may be controlled by a controller provided separately.

For temperature measurement of the substrate for temperature measurement TW placed on the heat-treat plate 31, the selector 21 is first switched to the transmitter 22, thereby to establish individual connections between the plurality of temperature measuring elements 15 and the transmitter 22 via the cables 50. Then, the transmitter 22 transmits electrical signals with frequencies corresponding to the characteristic frequencies of the quartz resonators 18 of the seventeen temperature measuring elements 15 provided in the substrate for temperature measurement TW. The frequencies of the transmitted electrical signals are also transmitted from the transmitter 22 to the temperature computer 29. According to the temperature measuring system of the first example with cable connections, the characteristic frequencies of the seventeen quartz resonators 18 shall be in the same frequency band. Thus, the transmitter 22 can transmit electrical signals with the same frequency in unison to the plurality of temperature measuring elements 15.

The electrical signals transmitted from the transmitter 22 are individually transmitted in unison via the cables 50 to the seventeen temperature measuring elements 15. Consequently, the quartz resonators 18 of the seventeen temperature measuring elements 15 resonate almost simultaneously. Subsequently, upon termination of the electrical signal transmission due to the transmitter 22 stopping transmission, the selector 21 is switched to the receiver 23.

The termination of the electrical signal transmission causes damped oscillation of the aforementioned seventeen quartz resonators 18 which have resonated, at frequencies corresponding to the temperature of the substrate for temperature measurement TW (precisely the temperatures of the substrate at the positions at which the quartz resonators 18 are mounted). Then, electrical signals caused by this damped oscillation are transmitted from the quartz resonators 18. The electrical signals transmitted from the seventeen quartz resonators 18 are individually and almost simultaneously received by the receiver 23. The frequency counter 24 individually counts the frequencies of the electrical signals transmitted from the seventeen resonators 18 and received by the receiver 23, and transmits the counted values to the temperature computer 29. The temperature computer 29 computes the rate of change of the transmit-receive frequencies based on the frequencies of the electrical signals counted by the frequency counter 24 and the frequencies of the electrical signals transmitted from the transmitter 22, and then based on that rate of change, individually computes the temperatures of the substrate for temperature measurement TW at the positions at which the seventeen quartz resonators 18 are mounted.

Through the processes described above, the temperature of a substrate placed on the heat-treat plate 31 can be measured using the substrate for temperature measurement TW. By the way, in the course of placing and heating the substrate for temperature measurement TW, which have the temperature measuring elements 15 connected to the cables 50, on the heat-treat table 31, the temperature in the atmosphere of the substrate surface (the atmosphere around the cables 50) becomes lower than that of the heat-treat plate 31, which can cause measuring errors due to the cables 50 at relatively low temperatures having thermal influences on the temperature measuring elements 15. However in the substrate for temperature measurement TW, since all the seventeen cables 50 are of substantially equal length from their contacts AP with the temperature measuring elements 15 to their boundary points BP to the outside of the substrate, they are made to have uniform thermal influences on the temperature measuring elements 15. This results in substrate temperature measurement with extremely high precision.

In addition, since the seventeen cables 50 are bonded to the substrate for temperature measurement TW so that all the paths of the cables 50 from their contacts AP with the temperature measuring elements 15 to their boundary points BP to the outside of the substrate run on the upper surface of the substrate for temperature measurement TW, the temperatures of the seventeen cables 50 are made almost equal to that of the substrate for temperature measurement TW heated by the heat-treat plate 31. This minimizes thermal disturbances given to each of the temperature measuring elements 15 from the cables 50 and increases the accuracy of substrate temperature measurement. Here, covering the cables 50 with fluorocarbon resin having excellent heat resistance prevents the cover from suffering damage even if the temperatures of the cables 50 increase to be equal to that of the heated substrate for temperature measurement TW.

Further, forming the plurality of recesses 11 in the surface of the substrate for temperature measurement TW and mounting the temperature measuring elements 15 therein enable high-precision substrate temperature measurement because the quartz resonators 18 enabling high-precision temperature measurement can measure the temperature of around the center of the substrate for temperature measurement TW in the direction of thickness.

Besides, as a result of forming the recesses 11 and fitting the temperature measuring elements 15 therein, the substrate for temperature measurement TW has almost the same heat capacity as a common substrate to be processed, and consequently, the substrate for temperature measurement TW after placed on the heat-treat plate 31 exhibits almost the same behavior of change in temperature as a common substrate to be processed. This further increases the accuracy of temperature measurement of a substrate to be processed which is placed on the heat-treat plate 31.

Furthermore, the temperature measuring system of the first example provides individual cable connections between the seventeen temperature measuring elements 15 in the substrate for temperature measurement TW and the transmitter-receiver 20 via the cables 50. This not only ensures the transmission and reception of electrical signals, but also allows simultaneous transmission of electrical signals with the same frequency to the quartz resonators 18 of the seventeen temperature measuring elements 15 and almost simultaneous reception of electrical signals from the quartz resonators 18 of the seventeen temperature measuring elements 15. This results in shortening of sampling time required for a single temperature measurement and therefore an increase in the number of temperature measurements per unit time (e.g., about one temperature measurement per second). Accordingly, the accuracy of substrate temperature measurement can further be increased.

Second Example of Temperature Measuring System

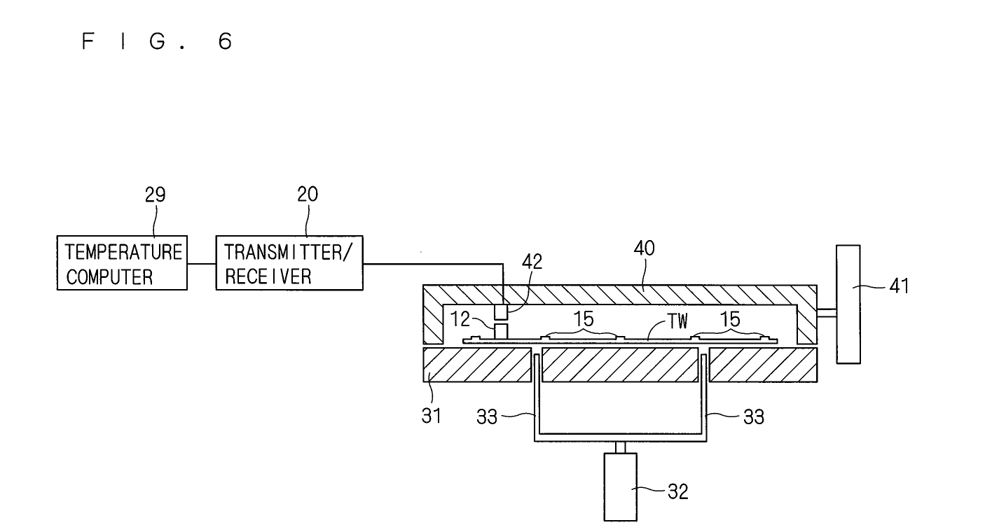

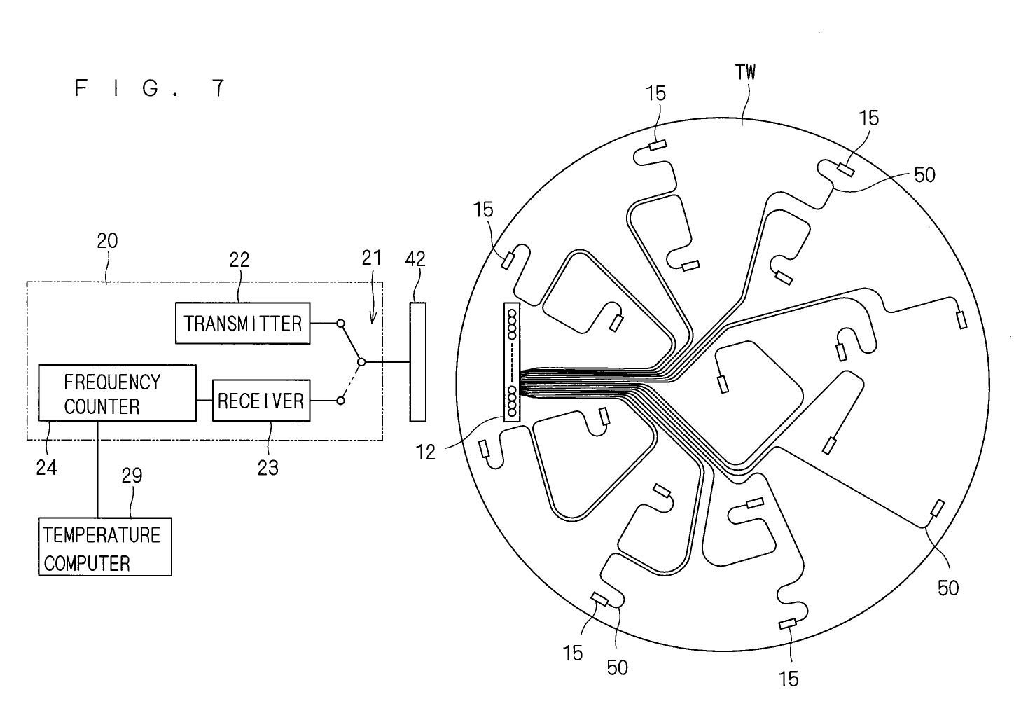

Next, a second example of the temperature measuring system using the substrate for temperature measurement TW will be described. FIG. 6 is an overall configuration view of the temperature measuring system of the second example and FIG. 7 is a configuration view of the various parts thereof. In the second example, also, the temperature of a substrate placed on the heat-treat plate 31 in the heat processing unit 30 is measured using the substrate for temperature measurement TW. The second example differs from the first example only in the form of connection between the transmitter-receiver 20 and the temperature measuring elements 15. In the other respects, it is the same as the first example, so elements which are common to those shown in FIGS. 4 and 5 are designated by the same reference numerals in FIGS. 6 and 7.

In the temperature measuring system of the second example, a substrate-side connector 12 is fixedly provided on the upper surface (or the surface) of the substrate for temperature measurement TW. The substrate-side connector 12 is provided with seventeen pairs of terminals (each pair of terminals consisting of two contacts) which are placed in rows facing upward. Each of the seventeen pairs of terminals is connected in a one-to-one correspondence with the seventeen temperature measuring elements 15. Connections between the terminals of the substrate-side connector 12 and the temperature measuring elements 15 are established by using the co-axial cables 50 similar to those described in the above example. The form of connection between the temperature measuring elements 15 and the cables 50 is exactly the same as that described in the aforementioned first example (see FIG. 2).

Now, in the second example, the other ends of the cables 50 are connected to the substrate-side connector 12. That is, according to the second example, the substrate-side connector 12 corresponds to the boundary points BP to the outside of the substrate for temperature measurement TW. The second example is identical to the first example in the aspect that the seventeen cables 50 providing connection between the temperature measuring elements 15 and the substrate-side connector 12 each are bonded and fixed using an adhesive on the upper surface of the substrate for temperature measurement TW. All the seventeen cables 50 are of substantially equal length from their contacts AP with the temperature measuring elements 15 to their boundary points BP (i.e., the substrate-side connector 12) to the outside of the substrate for temperature measurement TW through on the surface of the substrate for temperature measurement TW. Also, all the paths of all the seventeen cables 50 from the contacts AP with the temperature measuring elements 15 to the boundary points BP to the outside of the substrate always run on the substrate without deviating from and running outside of the substrate at all.

In other words, as in the second example, the seventeen cables 50 are bonded to the substrate for temperature measurement TW so that all the paths of the cables 50 from the contacts AP with the temperature measuring elements 15 to the boundary points BP (i.e., the substrate-side connector 12) to the outside of the substrate run on the upper surface of the substrate for temperature measurement TW, and that they are made to have a substantially equal length from their contacts AP to their boundary points BP.

Further, a cover-side connector 42 is fixedly provided on the underside of the plate cover 40. The cover-side connector 42 is also provided with seventeen pairs of terminals which are placed in rows facing downward. Each of the seventeen pairs of terminals of the cover-side connector 42 is individually connected to the transmitter-receiver 20.

When the lifting mechanism 41 moves the plate cover 40 downward, the substrate-side connector 12 and the cover-side connector 42 fit into each other to establish connections between the seventeen pairs of terminals of both the connectors. This results in the establishment of individual connections (cable connections) between the seventeen temperature measuring elements 15 in the substrate for temperature measurement TW and the transmitter-receiver 20 via the substrate-side connector 12 and the cover-side connector 42. When the lifting mechanism 41 moves the plate cover 40 upward, the substrate-side connector 12 and the cover-side connector 42 are alienated from each other to break the connections between the temperature measuring elements 15 and the transmitter-receiver 20.

For temperature measurement in the temperature measuring system of the second example, the substrate for temperature measurement TW is first placed on the heat-treat plate 31, and then the lifting mechanism 41 moves the plate cover 40 downward to establish connection between each of the seventeen temperature measuring elements 15 in the substrate for temperature measurement TW and the transmitter-receiver 20. The temperature measuring technique in the subsequent process is identical to that described in the above first example, in which electrical signals are individually transmitted to the quartz resonators 18 of the seventeen temperature measuring elements 15; upon termination of the transmission, electrical signals from the quartz resonators 18 of the seventeen temperature measuring elements 15 are received; the rate of change of transmit/receive frequencies is computed by the temperature computer 29; and the temperatures of the substrate for temperature measurement TW at the positions at which the seventeen quartz resonators 18 are mounted are individually computed based on that rate of change.

The aforementioned second example can also achieve similar effects as those described in the above first example, e.g., enables substrate temperature measurement with extremely high precision. Especially, the second example, in which the connections between the temperature measuring elements 15 and the transmitter-receiver 20 are established by moving the plate cover 40 downward, simplifies the handling of wiring.

While the illustrated embodiments of the present invention have been described so far, various modifications and variations can be made other than the aforementioned examples, without departing from the scope of the present invention. For example, while, in the above illustrated embodiments, the substrate for temperature measurement TW has formed therein the recesses 11 into which then the temperature measuring elements 15 are mounted, the temperature measuring elements 15 may be bonded simply to the substrate surface without formation of the recesses 11. Even in this case, all the cables 50 are bonded to the substrate for temperature measurement TW so that all the paths of the cables 50 from the contacts AP with the temperature measuring elements 15 to the boundary points BP to the outside of the substrate run on the upper surface of the substrate for temperature measurement TW, and that they are made to have a substantially equal length from their contacts AP to their boundary points BP. This minimizes and makes uniform thermal disturbances given to the temperature measuring elements 15 from the cables 50, thus enabling high-precision substrate temperature measurement.

While, in the aforementioned embodiments, the plurality of cables 50 are tied together in a single bundle in the vicinity of the boundary points BP as shown in FIG. 3, the boundary points BP of the cables 50 to the outside of the substrate may be completely isolated from one another, or they may be tied together in a plurality of bundles. In either case, all the cables 50 are bonded to the substrate for temperature measurement TW so that all the paths of the cables 50 from the contacts AP with the temperature measuring elements 15 to the boundary points BP to the outside of the substrate run on the upper surface of the substrate for temperature measurement TW, and that they are made to have a substantially equal length from their contacts AP to their boundary points BP.

The wiring pattern of the plurality of cables 50 is not limited to the example shown in FIG. 3, but may be in any form as long as all the cables 50 are of substantially equal length from their contacts AP with the temperature measuring elements 15 to their boundary points BP to the outside of the substrate.

As an alternative, such grooves as extending along the wiring pattern shown in FIG. 3 may be formed in the upper surface of the substrate for temperature measurement TW, and the plurality of cables 50 may be bonded and fixed into those grooves using an adhesive.

While, in the aforementioned illustrated embodiments, the seventeen temperature measuring elements 15 are mounted to the substrate for temperature measurement TW, the number of the temperature measuring elements 15 and their locations are arbitrary; for example, thirty-two temperature measuring elements 15 may be mounted in a single substrate for temperature measurement TW, or the number of those temperature measuring elements 15 may be sixty-four. Alternatively, the diameter of the substrate for temperature measurement TW may be 200 mm or other diameters associated with processed susbstrates.

The temperature measuring system according to the present invention is applicable to any device for heat treatment of a substrate to be processed which is placed on a heat-treat plate, including a heating unit for heating a substrate placed on a hot plate and a cooling unit for cooling a substrate placed on a cool plate. As to heating units, the temperature measuring system according to the present invention is preferably applicable to those units which require precise temperature control, such as that for performing heating after exposure, and that for performing heating after resist coating.

While the invention has been shown and described in detail, the foregoing description is in all aspects illustrative and not restrictive. It is therefore understood that numerous modifications and variations can be devised without departing from the scope of the invention.

What is claimed is:

1. A substrate for temperature measurement configured to be placed on a heat-treat plate for heat treatment of a substrate to be processed, the substrate for temperature measurement comprising:
a substrate main body having a top surface, a bottom surface, and a peripheral surface disposed therebetween, wherein a boundary point is positioned on the peripheral surface;
a plurality of temperature measuring elements mounted to the substrate main body, each of the plurality of temperature measuring elements having a quartz resonator and a contact; and
a plurality of cables, each of the plurality of cables individually connected to one of the plurality of temperature measuring elements and configured to transmit electrical signals, each of the plurality of cables having a substantially equal length measured from the contact with the one of the plurality of temperature measuring elements to the boundary point positioned on the peripheral surface of the substrate main body.

2. The substrate for temperature measurement of claim 1 wherein one or more of the plurality of cables is bonded to the substrate main body from the contact to the boundary point.

3. The substrate for temperature measurement of claim 2 wherein all of the plurality of cables are bonded to the substrate main body from the contact to the boundary point.

4. The substrate for temperature measurement of claim 2 wherein the plurality of cables are characterized by a meandering shape when viewed normal to the substrate main body.

5. The substrate for temperature measurement of claim 1 wherein the plurality of temperature measuring elements are mounted in recesses formed in the top surface of the substrate main body.

6. The substrate for temperature measurement of claim 1 wherein the quartz resonators comprise a Ys-cut quartz crystal.

7. A temperature measuring system for measuring a temperature of a substrate placed on a heat-treat plate, the temperature measuring system comprising:
a substrate for temperature measurement including:
a substrate main body having a top surface, a bottom surface, and a peripheral surface disposed therebetween, wherein a boundary point is positioned on the peripheral surface;
a plurality of temperature measuring elements mounted to the substrate main body, each of the plurality of temperature measuring elements having a quartz resonator and a contact; and
a plurality of cables, each of the plurality of cable individually connected to one of the plurality of temperature measuring elements and configured to transmit electrical signals, each of the plurality of cables having a substantially equal length measured from the contact with the one of the plurality of temperature measuring elements to the boundary point positioned on the peripheral surface of the substrate main body;
a transmitter-receiver coupled to the plurality of cables, the transmitter-receiver configured to transmit and receive electrical signals to and from each of the plurality of temperature measuring elements; and
a temperature computer configured to compute the temperature of the substrate based on frequencies of electrical signals transmitted from each of the plurality of temperature measuring elements and received by the transmitter-receiver.

8. The temperature measuring system of claim 7 wherein one or more of the plurality of cables is bonded to the substrate main body from the contact to the boundary point.

9. The temperature measuring system of claim 8 wherein all of the plurality of cables are bonded to the substrate main body from the contact to the boundary point.

10. The temperature measuring system of claim 8 wherein the plurality of cables are characterized by a meandering shape when viewed normal to the substrate main body.

11. The temperature measuring system of claim 7 wherein the plurality of temperature measuring elements are mounted in recesses formed in the top surface of the substrate main body.

12. The temperature measuring system of claim 7 further comprising a frequency counter coupled to the receiver and the temperature computer.

13. The temperature measuring system of claim 7 wherein the quartz resonators comprise a Ys-cut quartz crystal.
